(19) United States
(12) Patent Application Publication
(10) Pub. No.: US 2021/0246904 A1
(43) Pub. Date: Aug. 12, 2021

(54) CENTRIFUGAL PROTECTIVE BLOWER

(71) Applicant: Yayao Feite Plastic Co., Ltd., Zhejiang Province (CN)

(72) Inventor: Chaoqiang Zhou, Hunan (CN)

(21) Appl. No.: 17/251,480

(22) PCT Filed: Apr. 12, 2019
(86) PCT No.: PCT/CN2019/082515

§ 371 Date: Dec. 11, 2020

(30) Foreign Application Priority Data
Jun. 13, 2018 (CN) 201810609245.2

(51) Int. Cl. F04D 29/22; A45D 20/12; F24H 3/02; F04D 27/00; F04D 29/02; F04D 29/42; F04D 29/58; G06T 7/246; G06K 9/00; G06K 9/42; G06K 9/38; G06K 9/54; G06K 9/34

(52) U.S. Cl. CPC F04D 29/2294; G06K 2209/21; F24H 3/022; F04D 27/006; F04D 29/023; F04D 29/4226; F04D 27/00; F04D 29/58; G06T 7/246; G06K 9/00624; G06K 9/42; G06K 9/38; G06K 9/54; G06K 9/00362; G06K 9/34; A45D 20/12

(57) ABSTRACT

A centrifugal protective hair blower, comprising a plastic shell for wrapping powered devices of the blower, wherein the plastic shell is made of polycarbonate casting; an electric heating device which is arranged in the plastic shell of the hair blower, composed of a two to three sections electric heating wire, and is used to control the blowing temperature of the hair blower; a hemispherical picture-shooting mechanism, which includes a trailing measurement device, an image interception device, a data analysis device, a DC drive motor, an optical filter, optical lens and an image sensing device; an electric heating device, which is connected with a vector analysis device, and is used to reduce the blowing temperature of the hair blower when the target type is a cat, a dog or a rabbit. Through the present invention, it is capable of preventing the hair blower from causing unwarranted injury to surrounding pets.

### TECHNICAL FIELD

The present invention relates to the field of hair blowers, in particular to a centrifugal protective type hair blower.

### BACKGROUND ART

Centrifugal hair blowers are based on the principle of converting kinetic energy into potential energy, using a high-speed rotating impeller to accelerate the air, then decelerates, changing the flow direction, and converts kinetic energy into potential energy (pressure). In a single-stage centrifugal fan, the air enters the impeller from the axial direction, changes to the radial direction when the air flows through the impeller, and then enters the diffuser. In the diffuser, the air changes the direction of flow to cause deceleration, which converts kinetic energy into pressure energy. The increase in pressure mainly occurs in the impeller, followed by the expansion process. In a multi-stage centrifugal fan, a refluxer is used to make the air flow into the next impeller, thus generating higher pressure.

### SUMMARY OF THE INVENTION

In order to solve the technical problem of the hazards of hair blowers when unused, the present invention provides a centrifugal protective hair blower, which adopts a stepwise operation mode to improve the pertinence of image contrast characteristics, and adopts a CPLD chip to realize noise detection and analysis of image. On this basis, a data correction device is used to perform adaptive correction of segmentation threshold, thereby improving the accuracy of subsequent detection. When the trailing phenomenon caused by jitter is detected, the image content is analyzed, specifically, determines the displacement vector of the image based on each red channel value of each pixel of the image, and use the built-in motor of a hemispherical picture-shooting mechanism to correct the corresponding displacement. On the basis of the above data processing, when the existence of surrounding pet objects is identified, the blowing temperature of hair blower is reduced to avoid unprovoked injury to pets.

According to one aspect of the present invention, a centrifugal protective hair blower is provided, wherein the hair blower comprises:

a plastic shell for wrapping various electrical device of the hair blower, and the plastic shell is made of polycarbonate casting.

More specifically, the centrifugal protective hair blower further comprises:

an electric heating device which is arranged in the plastic shell of the hair blower, composed of a two to three sections electric heating wire, and is used to control the blowing temperature of the hair blower.

More specifically, the centrifugal protective hair blower further comprises:

a hemispherical picture-shooting mechanism, which includes a trailing measurement device, an image interception device, a data analysis device, a DC drive motor, an optical filter, optical lens and an image sensing device;

wherein, the image sensing device is used for photoelectric sensing around the hair blower to output images around the hair blower.

More specifically, in the centrifugal protective hair blower:

the trailing measurement device is connected to the image sensing device, and is used to receive images around the hair blower, and performs image content measurement on the images around the hair blower to determine whether trailing patterns appear in the images around the hair blower, and sends out content trailing signal when trailing patterns exist, or else sends out content normal signal if no trailing pattern exists.

More specifically, the centrifugal protective hair blower further comprises:

the image interception device is respectively connected with the trailing measurement device and the image sensing device, and is used to output the image around the hair blower corresponding to the first content trailing signal as the image to be analyzed when the first content trailing signal is received, and to output the image around the hair blower closest to the image around the hair blower corresponding to the first content trailing signal as the image to be compared; the data analysis device is connected to the image interception device, and is used to receive the image to be analyzed and the image to be compared, determines the displacement vector of the image to be analyzed relative to the image to be compared based on the overall comparison between the image to be analyzed and the image to be compared, and outputs as the current displacement vector; the DC drive motor is respectively connected to the optical filter, the optical lens, the image sensing device and the data analysis device, and is used to control the optical filter, the optical lens, and the image sensing device to move together in opposite direction based on the displacement vector; a noise identification device, which is connected to the image sensing device, and is used to receive images around the hair blower, and performs noise type analysis on the images around the hair blower to obtain various noise types and the maximum amplitude corresponding to each type of noise in the images around the hair blower, and sorts the various noise types based on the order of the maximum amplitude from largest to smallest, and outputs the top five noise types as the five to-be-processed noise types; wherein the noise identification device is implemented by a CPLD chip, and the CPLD chip is further integrated with a memory for storing a type weight comparison table, and type weight comparison table saves the impact coefficient of each noise type on the binarization threshold, and is also used to store the initialized binarization threshold; a data correction device, which is connected to the noise identification device, and is used to receive the five types of noise to be processed, the initialized binarization threshold, and the type weight comparison table, and determines the five impact coefficients corresponding to the types of noise to be processed based on the type weight comparison table, and the five impact coefficients are used to perform sequential correction processing on the initialized binarization threshold to obtain the corrected threshold after the correction processing is completed, and outputs the correction threshold; a normalization processing device, which is connected to the data correction device, and uses the correction threshold to perform binarization processing on the image around the hair blower to obtain the image to be detected, and outputs the image to be detected; a first operating device, which is connected to the normalization processing device, and is used to receive the image to be detected, and to detect the existence of each target in the image to be detected, so as the number of targets exist in the image to be detected is used as the target statistical number, and outputs the target statistical number; a second operating device, which is connected to the first operating device, and is used to receive the target statistical number, and sends out quantity overflow information when the target statistical number is greater than or equal to a preset number threshold, and sends out quantity normal information when the target number is smaller than the preset number threshold; a third operating device, which is respectively connected to the first operating device and the target decision device, and is used to receive the image to be detected, and is also used to perform a contrast enhancement processing to the image to be detected when the quantity overflow information is received to obtain the corresponding stepwise operation image, wherein the number of times the third operating device performs the contrast enhancement processing on the image to be detected is proportional to the target statistical number, and the third operating device stops the contrast enhancement processing of the image to be detected when receiving the quantity normal information; a vector composition device, which is connected to the third operating device, and is used to receive the stepwise operation image, and identifies the target in the stepwise operation image based on the target image gray threshold range to obtain the corresponding target zone, and determines several geometric features of the corresponding target based on the target zone: the number of Euler holes, roundness, the number of corner points, convexity and concavity, smoothness, length-diameter ratio, compactness and main axis angle, and combines the several geometric features into features vector; a vector analysis device, which is connected to the vector composition device, and adopts a single hidden layer BP neural network with 8 inputs and 4 outputs, using the several geometric features as input layer neurons, and the output layer as a target type, wherein the target type includes cats, dogs, rabbits and non-pet types; a buzzer alarm device, which is connected to the vector analysis device, and is used to perform a buzzer alarm operation with a preset frequency when the target type is a cat, a dog or a rabbit; wherein, the electric heating device is also connected with the vector analysis device for reducing the blowing temperature of the hair blower when the target type is a cat, a dog or a rabbit.

More specifically, in the centrifugal protective hair blower: the optical filter is arranged in front of the optical lens, and the image sensing device is arranged in front of the optical lens.

More specifically, in the centrifugal protective hair blower: in the data analysis device, determining the displacement vector of the image to be analyzed relative to the image to be compared based on the overall comparison between the image to be analyzed and the image to be compared, which includes: acquiring each red channel value of each pixel of the image to be analyzed and each red channel value of the image to be compared, and determines the displacement vector of the image to be analyzed relative to the image to be compared based on each red channel value of each pixel of the image to be analyzed and each red channel value of the image to be compared.

### DETAILED IMPLEMENTTION METHOD

The embodiments of the centrifugal protective blower of the present invention will be described in detail below.

It adopts the latest design, which comprises two rows of large-spacing cupolas that meet the “three modernizations” standards. It is a cupola commonly used in the domestic foundry industry. Its main structural feature is that there are two rows of air outlets which are far apart, and two independent combustion zones are formed by bottom coke combustion. By extending the superheating zone, the hot metal overheating path and the fierce combustion of the bottom coke are increased. The furnace condition is stable, the molten iron temperature is high, and the molten iron quality is good. According to the air supply temperature, it can be divided into two structures: cold air and furnace hot air. Different air temperatures are used to achieve different melting requirements. Furnace hot-air type uses dense-rib furnace heat exchanger to heat the physical heat in the furnace, thereby heating the cold air entering into the furnace. The hot air temperature is about 180-250° C. Its features including occupying a small production area in the workshop, is compact in structure, convenient in operation and with low thermal inertia.

In order to overcome the above shortcomings, the present invention builds a centrifugal protective hair blower, which can effectively solve the corresponding technical problems.

The centrifugal protective hair blower according to the embodiment of the present invention includes:

a plastic shell for wrapping various electrical device of the hair blower, and the plastic shell is made of polycarbonate casting.

Next, the specific structure of the centrifugal protective hair blower of the present invention is further described.

The centrifugal protective hair blower further comprises:

an electric heating device which is arranged in the plastic shell of the hair blower, composed of a two to three sections electric heating wire, and is used to control the blowing temperature of the hair blower.

The centrifugal protective hair blower further comprises:

a hemispherical picture-shooting mechanism, which includes a trailing measurement device, an image interception device, a data analysis device, a DC drive motor, an optical filter, optical lens and an image sensing device;

wherein, the image sensing device is used for photoelectric sensing around the hair blower to output images around the hair blower.

In the centrifugal protective hair blower: the trailing measurement device is connected to the image sensing device, and is used to receive images around the hair blower, and performs image content measurement on the images around the hair blower to determine whether trailing patterns appear in the images around the hair blower, and sends out content trailing signal when trailing patterns exist, or else sends out content normal signal if no trailing pattern exists.

The centrifugal protective hair blower further comprises:

the image interception device is respectively connected with the trailing measurement device and the image sensing device, and is used to output the image around the hair blower corresponding to the first content trailing signal as the image to be analyzed when the first content trailing signal is received, and to output the image around the hair blower closest to the image around the hair blower corresponding to the first content trailing signal as the image to be compared;

the data analysis device is connected to the image interception device, and is used to receive the image to be analyzed and the image to be compared, determines the displacement vector of the image to be analyzed relative to the image to be compared based on the overall comparison between the image to be analyzed and the image to be compared, and outputs as the current displacement vector;

the DC drive motor is respectively connected to the optical filter, the optical lens, the image sensing device and the data analysis device, and is used to control the optical filter, the optical lens, and the image sensing device to move together in opposite direction based on the displacement vector;

a noise identification device, which is connected to the image sensing device, and is used to receive images around the hair blower, and performs noise type analysis on the images around the hair blower to obtain various noise types and the maximum amplitude corresponding to each type of noise in the images around the hair blower, and sorts the various noise types based on the order of the maximum amplitude from largest to smallest, and outputs the top five noise types as the five to-be-processed noise types; wherein the noise identification device is implemented by a CPLD chip, and the CPLD chip is further integrated with a memory for storing a type weight comparison table, and type weight comparison table saves the impact coefficient of each noise type on the binarization threshold, and is also used to store the initialized binarization threshold;

a data correction device, which is connected to the noise identification device, and is used to receive the five types of noise to be processed, the initialized binarization threshold, and the type weight comparison table, and determines the five impact coefficients corresponding to the types of noise to be processed based on the type weight comparison table, and the five impact coefficients are used to perform sequential correction processing on the initialized binarization threshold to obtain the corrected threshold after the correction processing is completed, and outputs the correction threshold;

a normalization processing device, which is connected to the data correction device, and uses the correction threshold to perform binarization processing on the image around the hair blower to obtain the image to be detected, and outputs the image to be detected;

a first operating device, which is connected to the normalization processing device, and is used to receive the image to be detected, and to detect the existence of each target in the image to be detected, so as the number of targets exist in the image to be detected is used as the target statistical number, and outputs the target statistical number;

a second operating device, which is connected to the first operating device, and is used to receive the target statistical number, and sends out quantity overflow information when the target statistical number is greater than or equal to a preset number threshold, and sends out quantity normal information when the target number is smaller than the preset number threshold;

a third operating device, which is respectively connected to the first operating device and the target decision device, and is used to receive the image to be detected, and is also used to perform a contrast enhancement processing to the image to be detected when the quantity overflow information is received to obtain the corresponding stepwise operation image, wherein the number of times the third operating device performs the contrast enhancement processing on the image to be detected is proportional to the target statistical number, and the third operating device stops the contrast enhancement processing of the image to be detected when receiving the quantity normal information;

a vector composition device, which is connected to the third operating device, and is used to receive the stepwise operation image, and identifies the target in the stepwise operation image based on the target image gray threshold range to obtain the corresponding target zone, and determines several geometric features of the corresponding target based on the target zone: the number of Euler holes, roundness, the number of corner points, convexity and concavity, smoothness, length-diameter ratio, compactness and main axis angle, and combines the several geometric features into features vector;

a vector analysis device, which is connected to the vector composition device, and adopts a single hidden layer BP neural network with 8 inputs and 4 outputs, using the several geometric features as input layer neurons, and the output layer as a target type, wherein the target type includes cats, dogs, rabbits and non-pet types;

a buzzer alarm device, which is connected to the vector analysis device, and is used to perform a buzzer alarm operation with a preset frequency when the target type is a cat, a dog or a rabbit;

wherein, the electric heating device is also connected with the vector analysis device for reducing the blowing temperature of the hair blower when the target type is a cat, a dog or a rabbit.

In the centrifugal protective hair blower: the optical filter is arranged in front of the optical lens, and the image sensing device is arranged in front of the optical lens.

And, in the centrifugal protective hair blower: in the data analysis device, determining the displacement vector of the image to be analyzed relative to the image to be compared based on the overall comparison between the image to be analyzed and the image to be compared, which includes: acquiring each red channel value of each pixel of the image to be analyzed and each red channel value of the image to be compared, and determines the displacement vector of the image to be analyzed relative to the image to be compared based on each red channel value of each pixel of the image to be analyzed and each red channel value of the image to be compared.

In addition, the noise identification device is implemented by CPLD chips. CPLD (Complex Programmable Logic Device) is a device developed from PAL and GAL devices. It is relatively large in size and complex in structure and belongs to the scope of large-scale integrated circuits. It is a digital integrated circuit that users construct their own logic functions according to their needs. The basic design method is to use the integrated development software platform, use the schematic diagram, hardware description language and other methods to generate the corresponding target file, and transfer the code to the target chip through the download cable (“in-system” programming) to realize the designed digital system.

The CPLD is mainly composed of a programmable logic macro unit (MC, Macro Cell) around the center of the programmable interconnect matrix unit. The MC structure is complex and has a complex I/O unit interconnection structure, and the user can generate a specific circuit structure according to needs to complete a certain function. Since the internal length of the CPLD is interconnected by a fixed length of metal lines, the designed logic circuit has time predictability, which avoids the disadvantage of incomplete prediction of the segmented interconnect structure timing.

In view of the technical problem that the hair blower in the prior art is likely to cause harm to nearby pets, the centrifugal protective hair blower of the present invention is used, which adopts a stepwise operation mode to improve the pertinence of image contrast characteristics, and adopts a CPLD chip to realize noise detection and analysis of image. On this basis, a data correction device is used to perform adaptive correction of segmentation threshold, thereby improving the accuracy of subsequent detection. When the trailing phenomenon caused by jitter is detected, the image content is analyzed, specifically, determines the displacement vector of the image based on each red channel value of each pixel of the image, and use the built-in motor of a hemispherical picture-shooting mechanism to correct the corresponding displacement. On the basis of the above data processing, when the existence of surrounding pet objects is identified, the blowing temperature of hair blower is reduced to avoid unprovoked injury to pets, thereby solving the above technical problems.

It can be understood that, although the present invention has been disclosed as above in a preferred embodiment, the above-mentioned embodiment is not intended to limit the present invention. For anyone skilled in the art, without departing from the scope of the technical solution of the present invention, the technical content disclosed above can be used to make many possible changes and modifications to the technical solution of the present invention, or modified into embodiments of equivalent changes and efficacies. Therefore, any simple modification or equivalent changes made to the above embodiment without departing from the technical solution of the present invention based on the technical essence of the present invention still fall within the protection scope of the technical solution of the present invention.

1-7. (canceled)

8. A centrifugal protective hair blower, wherein the hair blower comprises:
a plastic shell for wrapping various electrical device of the hair blower, and the
plastic shell is made of polycarbonate casting.
characterized by the hair blower further comprises:
an electric heating device which is arranged in the plastic shell of the hair blower, composed of a two to three sections electric heating wire, and is used to control the blowing temperature of the hair blower.
characterized by the hair blower further comprises:
a hemispherical picture-shooting mechanism, which includes a trailing measurement device, an image interception device, a data analysis device, a DC drive motor, an optical filter, optical lens and an image sensing device;
wherein, the image sensing device is used for photoelectric sensing around the hair blower to output images around the hair blower.
characterized by:
the trailing measurement device is connected to the image sensing device, and is used to receive images around the hair blower, and performs image content measurement on the images around the hair blower to determine whether trailing patterns appear in the images around the hair blower, and sends out content trailing signal when trailing patterns exist, or else sends out content normal signal if no trailing pattern exists.
characterized by the hair blower further comprises:
the image interception device is respectively connected with the trailing measurement device and the image sensing device, and is used to output the image around the hair blower corresponding to the first content trailing signal as the image to be analyzed when the first content trailing signal is received, and to output the image around the hair blower closest to the image around the hair blower corresponding to the first content trailing signal as the image to be compared;
the data analysis device is connected to the image interception device, and is used to receive the image to be analyzed and the image to be compared, determines the displacement vector of the image to be analyzed relative to the image to be compared based on the overall comparison between the image to be analyzed and the image to be compared, and outputs as the current displacement vector;
the DC drive motor is respectively connected to the optical filter, the optical lens, the image sensing device and the data analysis device, and is used to control the optical filter, the optical lens, and the image sensing device to move together in opposite direction based on the displacement vector;
a noise identification device, which is connected to the image sensing device, and is used to receive images around the hair blower, and performs noise type analysis on the images around the hair blower to obtain various noise types and the maximum amplitude corresponding to each type of noise in the images around the hair blower, and sorts the various noise types based on the order of the maximum amplitude from largest to smallest, and outputs the top five noise types as the five to-be-processed noise types; wherein the noise identification device is implemented by a CPLD chip, and the CPLD chip is further integrated with a memory for storing a type weight comparison table, and type weight comparison table saves the impact coefficient of each noise type on the binarization threshold, and is also used to store the initialized binarization threshold;
a data correction device, which is connected to the noise identification device, and is used to receive the five types of noise to be processed, the initialized binarization threshold, and the type weight comparison table, and determines the five impact coefficients corresponding to the types of noise to be processed based on the type weight comparison table, and the five impact coefficients are used to perform sequential correction processing on the initialized binarization threshold to obtain the corrected threshold after the correction processing is completed, and outputs the correction threshold;
a normalization processing device, which is connected to the data correction device, and uses the correction threshold to perform binarization processing on the image around the hair blower to obtain the image to be detected, and outputs the image to be detected;
a first operating device, which is connected to the normalization processing device, and is used to receive the image to be detected, and to detect the existence of each target in the image to be detected, so as the number of targets exist in the image to be detected is used as the target statistical number, and outputs the target statistical number;
a second operating device, which is connected to the first operating device, and is used to receive the target statistical number, and sends out quantity overflow information when the target statistical number is greater than or equal to a preset number threshold, and sends out quantity normal information when the target number is smaller than the preset number threshold;
a third operating device, which is respectively connected to the first operating device and the target decision device, and is used to receive the image to be detected, and is also used to perform a contrast enhancement processing to the image to be detected when the quantity overflow information is received to obtain the corresponding stepwise operation image, wherein the number of times the third operating device performs the contrast enhancement processing on the image to be detected is proportional to the target statistical number, and the third operating device stops the contrast enhancement processing of the image to be detected when receiving the quantity normal information;
a vector composition device, which is connected to the third operating device, and is used to receive the stepwise operation image, and identifies the target in the stepwise operation image based on the target image gray threshold range to obtain the corresponding target zone, and determines several geometric features of the corresponding target based on the target zone: the number of Euler holes, roundness, the number of corner points, convexity and concavity, smoothness, length-diameter ratio, compactness and main axis angle, and combines the several geometric features into features vector;
a vector analysis device, which is connected to the vector composition device, and adopts a single hidden layer BP neural network with 8 inputs and 4 outputs, using the several geometric features as input layer neurons, and the output layer as a target type, wherein the target type includes cats, dogs, rabbits and non-pet types;
a buzzer alarm device, which is connected to the vector analysis device, and is used to perform a buzzer alarm operation with a preset frequency when the target type is a cat, a dog or a rabbit;
wherein, the electric heating device is also connected with the vector analysis device for reducing the blowing temperature of the hair blower when the target type is a cat, a dog or a rabbit.

9. The centrifugal protective hair blower of claim 8, characterized by:
the optical filter is arranged in front of the optical lens, and the image sensing device is arranged in front of the optical lens.

10. The centrifugal protective hair blower of claim 9, characterized by:
in the data analysis device, determining the displacement vector of the image to be analyzed relative to the image to be compared based on the overall comparison between the image to be analyzed and the image to be compared, which includes: acquiring each red channel value of each pixel of the image to be analyzed and each red channel value of the image to be compared, and determines the displacement vector of the image to be analyzed relative to the image to be compared based on each red channel value of each pixel of the image to be analyzed and each red channel value of the image to be compared.
